(19) United States
(12) Patent Application Publication
(10) Pub. No.: US 2009/0230215 A1
(43) Pub. Date: Sep. 17, 2009

(54) APPARATUS FOR GENERATING AND SPRAYING AN AEROSOL

(75) Inventors: Edmar Link, Karlsruhe (DE); Thomas Wendler, Karlsruhe (DE); Rudi Beideck, Eggenstein (DE)

Correspondence Address: DUANE MORRIS LLP - DC, 505 9th Street, Suite 1000, WASHINGTON, DC, 20004-2166, US

(73) Assignee: microjet GmbH, Karlsruhe (DE)

(21) Appl. No.: 12/400,048

(22) Filed: Mar. 9, 2009

(30) Foreign Application Priority Data
Mar. 11, 2008 (DE) 10 2008 013 540.2

(51) Int. Cl. B05B 7/26; B05B 7/00; B05B 17/04

(52) U.S. Cl. 239/338; 239/370; 239/413

(57) ABSTRACT

An apparatus for generating and spraying an aerosol which contains liquid particles in a gas stream and for pointedly supplying the aerosol to a lubricating location, comprises
(a) a vessel containing a supply of liquid and a pressure space above the level of the liquid supply,
(b) an atomizer disposed in the pressure space above the level of the liquid supply and comprising:
   (i) a spraying device for spraying the aerosol,
   (ii) a liquid feed line connected at one end to the liquid supply and its other end to the spraying device and including a pump for feeding the liquid,
   (iii) a gas feed line connected at one end to a pressure gas source and at its other end to the spraying device,
   (iv) at least one apertured wall disposed in the way of the trajectories of the spray jets from the spraying device and having holes for passing liquid particles of a predetermined size while separating greater liquid particles at the apertured wall, and
(c) an aerosol line which connects the pressure space with a machining location to be wetted by the aerosol.

The instant invention relates to an apparatus for generating and spraying an aerosol which contains liquid particles in a gas stream and for pointedly supplying the aerosol to a lubricating location, especially for use in minimum quantity lubrication techniques where minute amounts of lubricating oil must be fed to the location at which a material treating process is performed, e.g. a place of cutting or deforming objects.

In a known apparatus of this kind (WO 98/28085) an injector device is provided to produce a mixture of gas and liquid which exits in the form of a gas/liquid jet from an outlet, hitting the structured surface of an impact body, such as a stepped pyramid, and thereby forming a gas/liquid mist.

Another known apparatus for producing a gas/liquid mixture operates according to the injector principle, whereby a gas/liquid jet generated by an injector is sprayed onto the tip of a pyramid which is set into rotating motion by a drive means (DE 203 09 452 U1).

The liquid particles in a gas stream issuing from a spraying device, such as a nozzle, should be extremely small, i.e. in an order of magnitude of 1 μm or less, so that they may be kept afloat after spraying across the longest possible distance and thus be conveyed directly to the place of application.

It is, therefore, an object of the invention to provide an apparatus of the kind specified initially by which an aerosol containing minute liquid droplets can be produced economically, the consistency of said aerosol when sprayed and conveyed being maintained all the way to the place of application even across great conveying distances.

Claim 1 serves to meet the object defined above. Claim 1 specifies an apparatus which comprises:
(a) a vessel containing a supply of liquid and a pressure space above the level of the liquid supply,
(b) an atomizer disposed in the pressure space above the level of the liquid supply and comprising:
(i) a spraying device for spraying the aerosol,
(ii) a liquid feed line connected at one end to the liquid supply and at its other end to the spraying device and including a pump for feeding the liquid,
(iii) a gas feed line connected at one end to a pressure gas source and at its other end to the spraying device,
(iv) at least one apertured wall disposed in the way of the trajectories of the spray jets from the spraying device and having holes for passing liquid particles of a predetermined size while separating greater liquid particles at the apertured wall, and
(c) an aerosol line which connects the pressure space with a machining location to be wetted by the aerosol.

The apparatus according to the invention is devised so as to provide an aerosol containing liquid particles of smallest dimensions which are maintained as such even after a rather long conveying distance to the place of application, for example a location where a cutting process or cold deformation is performed. The spraying takes place without any relative movement between the spraying device and the apertured wall and without electric energy input, simply by the pressure energy of the gas/liquid stream. The operating pressure of the gas used, e.g. air, may be adjusted to values between 1 bar and 7 bars, depending on the respective case of treatment, e.g. cutting or milling.

In a preferred embodiment of the invention, the apertured wall is of cylindrical shape and the spraying device is disposed in the centre of the apertured wall and adapted to spray the aerosol all around in outward direction against the apertured wall. In this manner, an aerosol mist uniformly distributed around the apertured wall is generated in the pressure space radially outside of the apertured wall.

The dimensions of the liquid particles carried along in the mist can be successfully diminished further by arranging another apertured wall downstream and spaced from the outside of the first mentioned apertured wall.

Testing in practice proved that a particularly useful embodiment is obtained when three cylindrical apertured walls are arranged concentrically around the spraying device.

The or each apertured wall preferably is made from thin sheet material of corrosion resistant metal which is easily bent into the desired shape, such as especially stainless steel. The holes in the apetured wall or walls should have hole dimensions of less than 500 μm, preferably less than 200 μm.

The holes in the apertured wall may be provided in a regular pattern and be separated by webs whose width is smaller than the hole diameters. The holes in an embodiment which proved successful in testing are of diamond shape. The holes may be arranged in mutually offset rows in the manner of honeycombs and they may be of hexagonal or round shape.

In a preferred embodiment of the invention the spraying device comprises a nozzle head including a mixing chamber and a twist body arranged in the mixing chamber. At least one helical groove with a baffle face is formed in the circumference of the twist body to cause a twist of the gas/liquid streams as described in DE 196 08 485 C2.

In order for the gas/liquid mixture prepared in the mixing chamber to be sprayed as uniformly as possible onto the inner circumference of the apertured wall, the spraying device may comprise a nozzle mouth formed with a ring of outlet orifices which are directed at a deflector face of a jet deflecting body inserted in the nozzle mouth to guide the issuing spray jets in the direction of the apertured wall.

The invention will be described further, by way of example, with reference to the accompanying drawings, in which:

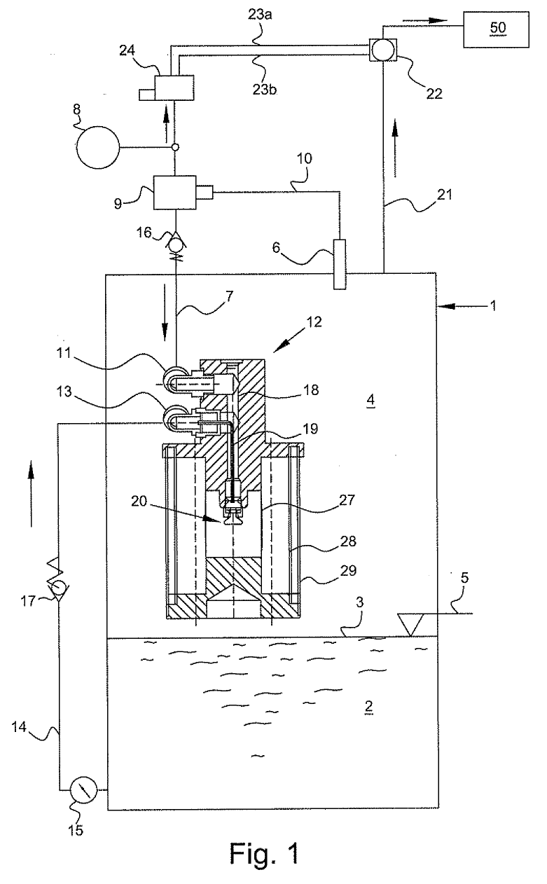

FIG. 1 is a diagrammatic illustration of an apparatus for generating and spraying an aerosol according to the invention;

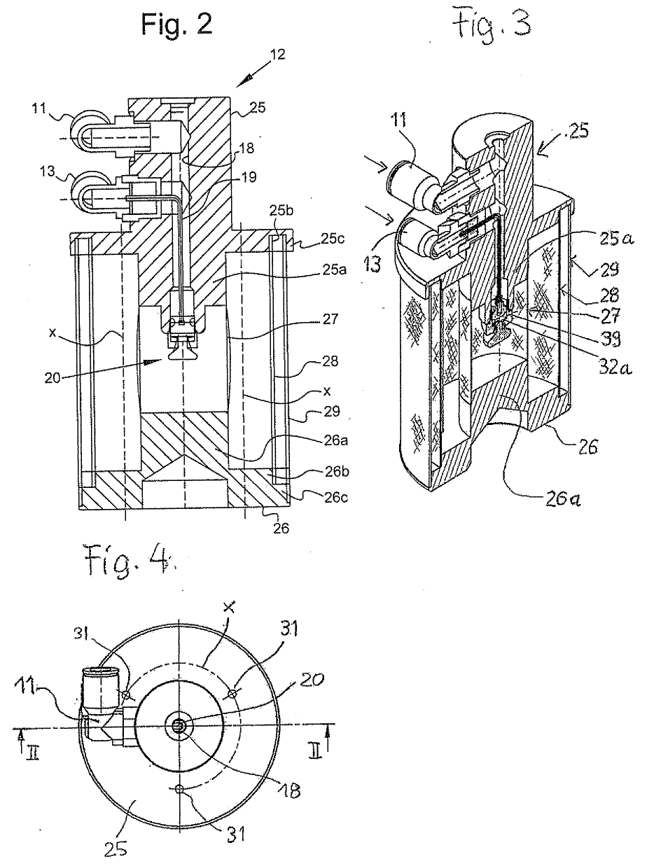

FIG. 2 is an axial sectional elevation along line II-II in FIG. 4 showing a spraying device of the apparatus according to the invention;

FIG. 3 is a perspective view of the axial sectional elevation according to FIG. 2;

FIG. 4 is a top plan view of the spraying device shown in FIG. 2;

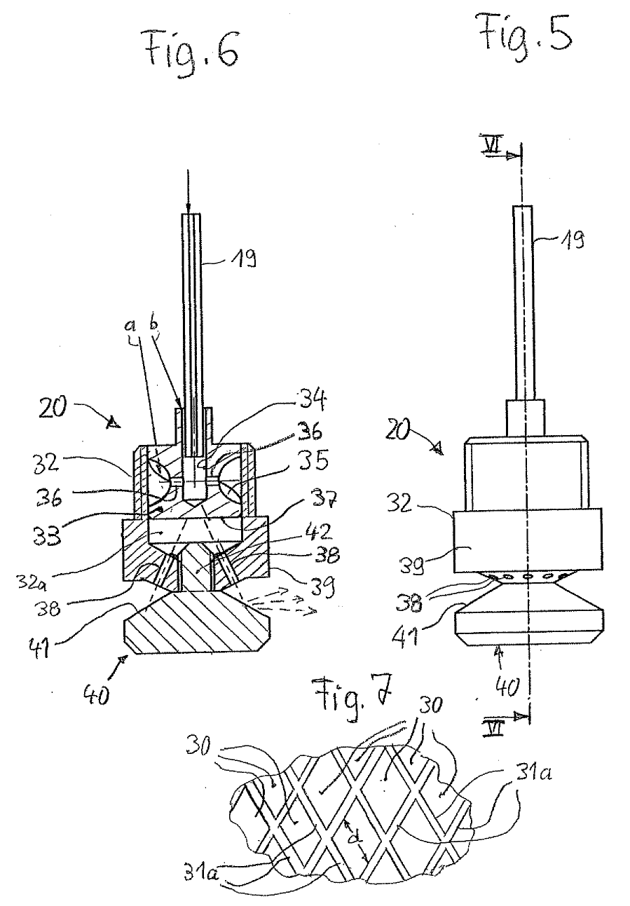

FIG. 5 is a view of a nozzle head of the spraying device, shown on an enlarged scale;

FIG. 6 is a sectional view along line VI-VI in FIG. 5; and

FIG. 7 is a greatly enlarged partial view of a section of an apertured wall according to the invention, having diamond-shaped holes.

FIG. 1 diagrammatically illustrates the entire apparatus for generating and spraying an aerosol.

The apparatus comprises a pressure-sealed vessel 1 containing a supply of oil 2 in its lower part, while a pressure space 4 is defined above the level 3 of the oil supply. The surface of the level 3 is monitored by a level sensor 5, and the pressure in the pressure space 4 is monitored by a pressure sensor 6.

A solenoid valve 9 connected to the pressure sensor 6 by a pressure signal line 10 is inserted in a compressed air feed line 7 coming from a pressure source 8. The compressed air feed line 7 is connected to an air inlet connecting piece 11 of a spraying device designated generally by reference numeral 12. The pressure sensor 6 functions to switch off and on the supply of compressed air when a pressure maximum is exceeded and a pressure minimum is fallen short of, respectively. The operating pressure may be adjustable between 1 bar and 7 bars, depending on the particular case of treatment.

An oil inlet connecting piece 13 connected to an oil feed line 14 is provided below the air inlet connecting piece 11. The other end of the oil feed line 14 is connected to the oil supply 2 in the vessel 1. A gear pump 15 is installed in the oil feed line 14 and, when in switched-on state, it pumps oil from the oil supply 2 through the oil inlet connecting piece 13 into the spraying device 12. When a predetermined minimum level is fallen short off the level sensor 5 emits an alarm signal “refill vessel”, and when a maximum level is surpassed it emits a signal “stop oil supply”. Both the air inlet connecting piece 11 and the oil inlet connecting piece 13 extend through the wall of the vessel 1 fixedly so that the spraying device 12 is kept stationary within the vessel 1.

A check valve 16 is mounted in the compressed air feed line between the solenoid valve 9 and the air inlet connecting piece 11. A check valve 17 is mounted in the oil feed line 14 between the gear pump 15 and the oil inlet connecting piece 13.

A vertical longitudinal bore 18 is provided in the spraying device 12. Both the air inlet connecting piece 11 and the oil inlet connecting piece 13 open into this longitudinal bore 18, the oil flowing inside a capillary hose 19 through the oil inlet connecting piece 13 and the lower part of the longitudinal bore 18 to a nozzle head 20. An oil/air mixture produced in the nozzle head 20 is sprayed by the nozzle head 20 radially in all directions outwardly into the pressure space 4, passing successively through three apertured walls 27, 28, 29 embodied by three concentric cylindrical, thin-walled sheets having perforated hole patterns. Thus the pressure space 4 is filled by the generated aerosol of the oil/air mixture.

An aerosol line 21 leads out of the pressure space 4 and is adapted to be blocked and unblocked by means of a ball valve 22. The ball valve 22 is controlled through air activating lines 23a, 23b by a solenoid valve 24 which is operable through the air feed line 7 by compressed air from the source 8.

FIGS. 2 to 4, once more, show the spraying device 12 on an enlarged scale and separate from the other component parts of the overall apparatus. The individual components of the spraying device 12 are to be seen more clearly in these figures than in FIG. 1. That is true in particular of the three apertured walls 27, 28, 29 with their holes through which the oil/air mixture formed within the nozzle head 20 is sprayed in radial direction from the inside to the outside. Greater droplets cannot pass the small holes in the apertured walls 27, 28, 29. Instead, they are separated at these apertured walls, whereas smaller oil droplets in passing through the holes are communicated still further so that they will be set floating in the aerosol which finally forms in the pressure space 4.

It may be taken from FIGS. 2 and 3 that the spraying device 12 comprises an upper casing portion 25 which contains the air inlet connecting piece 11 and the oil inlet connecting piece 13 as well as the longitudinal bore 18 and the nozzle head 20. It also comprises a lower casing portion 26 which is coaxial with the upper casing portion 25.

The two casing portions 25 and 26 have coaxial spigots 25a and 26a, respectively, facing in opposite directions and holding the innermost apertured wall 27 between them. Moreover, the upper and lower casing portions have coaxial, radially further outwardly located shoulders 25b, 26b which support the middle apertured wall 28. Finally, the upper casing portion 25 has an outer flange 25c and the lower casing portion 26 has an outer shoulder 26c, the flange 25c and shoulder 26c being axially aligned so that they can retain the outer apertured wall 29.

The upper and lower casing portions 25 and 26, respectively, are connected tight together by three screws 31 arranged equidistantly in a circle x as indicated by dash-dot lines, thereby firmly holding the apertured walls 27, 28, 29 between them. As FIGS. 2 and 6 show, the nozzle head 20 is threaded firmly into the upper casing portion 25.

The nozzle head 20 of the spraying device 12, shown on an enlarged scale in FIGS. 5 and 6, comprises a nozzle member 32 in which a twist body 33 is received. The inner end of the oil carrying capillary hose 19 is immersed with clearance in a central bore 34 formed in the twist body 33. A helical groove 35 is formed in the outer circumference of the twist body 33 to present a baffle face for generating twisting of the flow in the groove. The groove 35 communicates through a transverse bore 36 with the central bore 34 in the twist body 33. Therefore, gas and liquid can mix intimately inside the groove under the twisting effect and pressure. To that end compressed air is introduced in the direction of arrows “a” and “b” into the groove 35 and the clearance between the capillary hose 19 and the central bore 34.

The helical groove 35 opens into the mixing chamber proper 32a of the nozzle head 20 via an inferior front wall 37. The oil/air mixture flows on through a ring of outlet orifices 38 formed in a nozzle mouth 39 of the nozzle member 32 and impinges on an obtuse-angled deflector face 41 of a deflector head 40 which is screwed by a threaded trunnion 42 into a threaded hole in the nozzle mouth 39.

The mixed jets issuing from the outlet orifices are conveyed outwardly from the deflector face 41 approximately in radial direction (see dashed arrows in FIG. 6) against the cylindrical apertured wall 27. With thicker droplets being separated, the jets continue on their way through the holes of the other apertured walls 28 and 29 and into the pressure space 4 where finally an aerosol is formed containing most finely divided oil droplets of the minutest dimensions in an order of magnitude of less than 1 μm, preferably in the range of 0.5 μm. The aerosol thus obtained in the pressure space 4 ultimately is passed on through the aerosol line 21 and the ball valve 22 to a treatment location. This may be a place where cutting or cold deformation is performed, and it may be located at a great distance of, for example, 30 m and more. The aerosol is conveyed all the way without any impairing of the floating state of the minute oil particles in the pressure air.

The features disclosed in the specification above, in the claims, and drawings may be essential to the realization of the invention in its various modifications both individually and in any combination.

What we claim is:

1. An apparatus for generating and spraying an aerosol which contains liquid particles in a gas stream and for pointedly supplying the aerosol to a lubricating location, comprising
(a) a vessel containing a supply of liquid and a pressure space above the level of the liquid supply,
(b) an atomizer disposed in the pressure space above the level of the liquid supply and comprising:
(i) a spraying device for spraying the aerosol,
(ii) a liquid feed line connected at one end to the liquid supply and at its other end to the spraying device and including a pump for feeding the liquid,
(iii) a gas feed line connected at one end to a pressure gas source and at its other end to the spraying device,
(iv) at least one apertured wall disposed in the way of the trajectories of the spray jets from the spraying device and having holes for passing liquid particles of a predetermined size while separating greater liquid particles at the apertured wall, and
(c) an aerosol line which connects the pressure space with a treatment location to be wetted by the aerosol.

2. The apparatus as claimed in claim 1, wherein the apertured wall is cylindrical and a nozzle head of the spraying device is arranged in the centre of the apertured wall and arranged to spray the aerosol outwardly all around against the apertured wall.

3. The apparatus as claimed in claim 1, wherein at least one other apertured wall is arranged downstream of and spaced from the apertured wall.

4. The apparatus as claimed in claim 1, wherein three cylindrical apertured walls are arranged concentrically around the nozzle head.

5. The apparatus as claimed in any of claims 1, wherein the holes of the apertured wall have a hole diameter (d) of approximately 500 μm at most, preferably of 200 μm or less.

6. The apparatus as claimed in any of claims 1, wherein the holes of the apertured wall are disposed in a regular pattern and separated from one another by webs whose width is smaller than the hole diameters.

7. The apparatus as claimed in any of claims 1, wherein the holes of the apertured wall are diamond-shaped, hexagonal, or round.

8. The apparatus as claimed in any of claims 1, wherein the holes of the apertured wall are disposed in mutually offset rows in the manner of honeycombs.

9. The apparatus as claimed in any of claims 1, wherein the nozzle head of the spraying device comprises a mixing chamber with a twist body arranged inside it which has at least one helical groove with a baffle face formed in its circumference to produce twist of the gas/liquid streams.

10. The apparatus as claimed in claim 9, wherein the liquid stream is passed through a capillary hose into a central bore in the nozzle member and further on to the baffle face of the helical groove.

11. The apparatus as claimed in any of claims 1, wherein the nozzle head comprises a nozzle mouth formed with a ring of outlet orifices directed at a deflector face of a jet deflecting body inserted in the nozzle mouth to guide the issuing spray jets in the direction of the apertured wall.

12. The apparatus as claimed in any of claims 1, wherein the liquid is an oil as used in minimum quantity lubricating techniques and the gas is compressed air.

13. The apparatus as claimed in any of claims 1, wherein the apertured wall is formed of sheet material, especially made of stainless steel sheet having a wall thickness of less than approximately 0.5 mm.

14. The apparatus as claimed in any of claims 1, wherein the atomizer including the spraying device and the apertured wall/walls is arranged to be stationary in the vessel.

15. The apparatus as claimed in any of claims 1, wherein the gas operating pressure is adjustable in a range between approximately 1 bar and 7 bars.
